(19) United States
(12) Patent Application Publication
(10) Pub. No.: US 2008/0297841 A1
(43) Pub. Date: Dec. 4, 2008

(54) Printing Device and Computer Readable Medium Therefor

(75) Inventor: Kazuma AOKI, Kasugai (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: Brother Kogyo Kabushiki Kaisha, Nagoya (JP)

(21) Appl. No.: 12/129,068

(22) Filed: May 29, 2008

(30) Foreign Application Priority Data
May 30, 2007 (JP) 2007-143936

(51) Int. Cl. G06F 15/00

(52) U.S. Cl. 358/1.15

(57) ABSTRACT

A printing device, which is configured to execute a print job and perform a printing operation based on the print job, includes an interruption unit configured to perform an interruption process for interrupting a first print job in execution and executing a second print job, a calculating unit configured to calculate a ratio of a second time taken for a printing operation for the second print job to a first time taken for a printing operation for unprinted pages of the first print job, and a control unit configured to allow the interruption unit to perform the interruption process based on the ratio calculated by the calculating unit.

### CROSS-REFERENCE TO RELATED APPLICATION

This application claims priority under 35 U.S.C. §119 from Japanese Patent Application No. 2007-143936 filed on May 30, 2007. The entire subject matter of the application is incorporated herein by reference.

### BACKGROUND

1. Technical Field

The following description relates to one or more printing techniques such as an interruption process function of a printing device to let a second print job interrupt a first print job in execution and to execute the second print job.

2. Related Art

A printing device with an interruption process function is disclosed in Japanese Patent Provisional Publication No. 2003-134279 (hereinafter referred to as '279 Publication). When the printing device accepts a second print job during a printing operation for a first print job in execution, an interruption of the second print job into the first print job is permitted when a time difference between a first time period taken for completing the printing operation for the first print job after the acceptance of the second print job and a second time period taken for completing the printing operation for the second print job after the acceptance of the second print job is equal to or longer than a predetermined time period.

### SUMMARY

In the meantime, according to the above technique disclosed in '279 Publication, by comparing the time difference between the first time period and second time period with the fixed predetermined time period, a determination whether the interruption of the second print job is permitted. Therefore, the longer the first time period is, the less weight the time difference gives as a criterion for the determination (namely, the more the interruption of the second print job is likely to be allowed). Thus, it is undesired that the above technique might be less convenient for a user who has issued a print command of the first print job.

Aspects of the present invention provide one or more improved printing devices and computer readable media therefor with an interruption process function that is more convenient and user-friendly for a user.

According to aspects of the present invention, a printing device is configured to execute a print job and perform a printing operation based on the print job, and includes an interruption unit configured to perform an interruption process for interrupting a first print job in execution and executing a second print job, a calculating unit configured to calculate a ratio of a second time (T2) taken for a printing operation for the second print job to a first time (T1) taken for a printing operation for unprinted pages of the first print job, and a control unit configured to allow the interruption unit to perform the interruption process based on the ratio calculated by the calculating unit.

In some aspects of the present invention, the degree of effect of an interrupting print job on an interrupted print job is constant regardless of the length of T1. Thus, it is possible to make the printing device more convenient and user-friendly, decreasing a sense of inequality that might be held by an interrupting user or interrupted user.

According to another aspect of the present invention, a printing device is configured to execute a print job and perform a printing operation based on the print job, and includes an interruption unit configured to perform an interruption process for interrupting a first print job in execution and executing a second print job, a calculating unit configured to calculate a ratio of a third time (T3) to a first time (T1) taken for a printing operation for unprinted pages of the first print job, the third time being obtained by adding, to a second time (T2) taken for a printing operation for the second print job, at least one of a time taken for switching from the printing operation for the first print job to a printing operation for the second print job (hereinafter referred to as Tca) and a time taken for switching from the printing operation for the second print job to the printing operation for the first print job (hereinafter referred to as Tcb), and a control unit configured to allow the interruption unit to perform the interruption process based on the ratio calculated by the calculating unit.

In some aspects of the present invention, it is determined whether to allow the interruption process in consideration of at least one of time periods Tca and Tcb for switching the print job as well. Therefore, it can certainly be avoided to lessen the convenience and user-friendliness of the printing device for a user who has issued a print command of the first print job.

According to a further aspect of the present invention, there is provided a computer readable medium having computer readable instructions stored thereon, which cause a computer, configured to perform an interruption process to interrupt a first print job in execution and execute a second print job, to perform the steps of calculating a ratio of a second time taken for a printing operation for the second print job to a first time taken for a printing operation for unprinted pages of the first print job, determining whether the ratio calculated in the calculating step is less than or equal to a predetermined value, and performing the interruption process when it is determined in the determining step that the ratio is less than or equal to the predetermined value.

With the computer readable medium configured as above, since the degree of effect of an interrupting print job on an interrupted print job is constant regardless of the length of T1, the same effect as the aforementioned printing device can be provided.

### BRIEF DESCRIPTION OF THE ACCOMPANYING DRAWINGS

FIG. 1 is a block diagram of a printer in a first embodiment according to one or more aspects of the present invention.

FIGS. 2A and 2B schematically show a printing unit of the printer in the first embodiment according to one or more aspects of the present invention.

FIG. 3 shows a print job table in the first embodiment according to one or more aspects of the present invention.

FIG. 4 shows device status information of the printer in the first embodiment according to one or more aspects of the present invention.

FIG. 5 is a flowchart showing a print job receiving process to be executed in the printer when a print job is received in the first embodiment according to one or more aspects of the present invention.

FIGS. 6 and 7 are flowcharts showing a print control process to be executed in the printer in the first embodiment according to one or more aspects of the present invention.

FIG. 8 is a flowchart showing an effect level calculating process to be executed in the printer in the first embodiment according to one or more aspects of the present invention.

FIG. 9 is a graph showing a comparison of an effect level between the related art and the invention in the first embodiment according to one or more aspects of the present invention.

FIG. 10 is a flowchart showing an effect level calculating process to be executed in the printer in a second embodiment according to one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

Hereinafter, embodiments according to aspects of the invention will be described with reference to the accompanying drawings.

### First Embodiment

1. Brief Overview of Printer

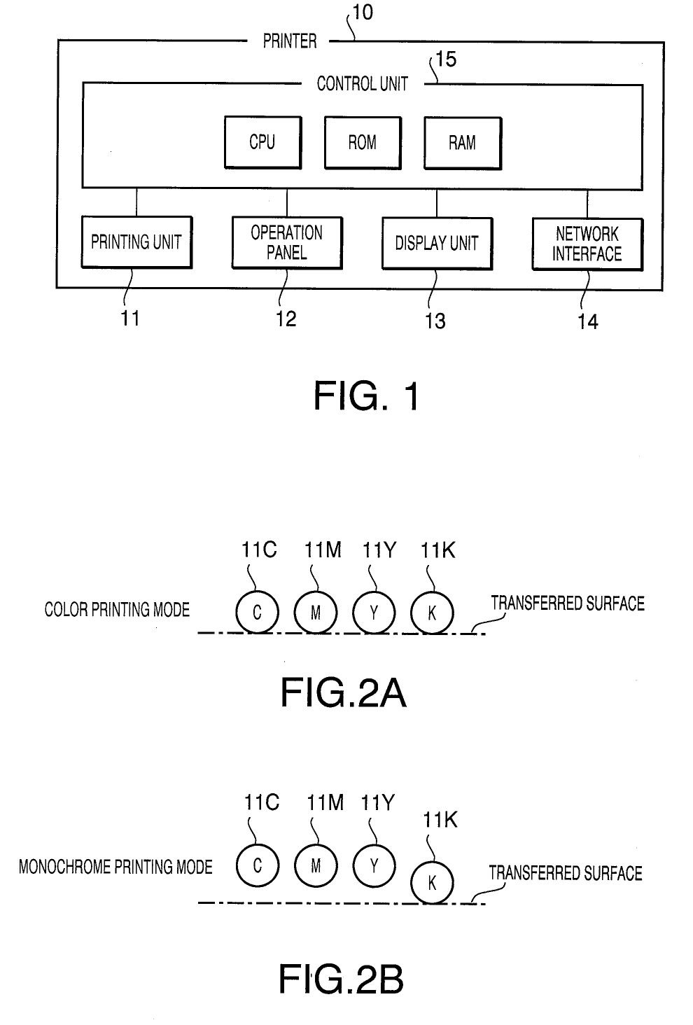

FIG. 1 is a block diagram schematically showing a configuration of a printer 10 according to aspects of the present invention. As shown in FIG. 1, the printer 10 is provided with a printing unit 11 configured to form an image on a recording medium such as a recording paper, an operation panel 12 to be operated by a user of the printer 10, a display unit 13 configured to display various information, an interface for network connection such as a Network Interface Card (NIC) 14, and a control unit 15 configured to control the above components connected therewith such as the printing unit 11.

It is noted that the control unit 15 is configured with a widely-known microcomputer that includes a CPU, ROM, and RAM, and programs for executing below-mentioned control processes, which are stored in the ROM.

Further, in the present embodiment, an electrophotographic image forming mechanism (printer engine) capable of color printing is employed as the printing unit 11. FIGS. 2A and 2B schematically show the printing unit 11. As shown in FIGS. 2A and 2B, the printing unit 11 is provided with a photoconductive drum 11K for transferring a black developer image onto a recording paper, a photoconductive drum 11Y for transferring a yellow developer image onto the recording paper, a photoconductive drum 11M for transferring a magenta developer image onto the recording paper, and a photoconductive drum 11C for transferring a cyan developer image onto the recording paper.

When performing color printing, as shown in FIG. 2A, the printing unit 11 moves all of the four photoconductive drums 11K, 11Y, 11M, and 11C onto their respective transfer positions. Further, when performing monochrome printing, as shown in FIG. 2B, the printing unit 11 sets the three photoconductive drums 11Y, 11M, and 11C other than the photoconductive drum 11K apart from their respective transfer positions.

Additionally, the control unit 15 judges on a page-by-page basis whether an image to be printed is a colored one, and takes a control for setting the respective locations of the four photoconductive drums 11K, 11Y, 11M, and 11C depending on the above determination (namely, the control unit 15 applies different locations of the photoconductive drums 11K, 11Y, 11M, and 11C between the color printing and monochrome printing).

In the printer 10 of the present invention, in cases where a printing mode is switched from a color printing mode to a monochrome printing mode and where the printing mode is switched from the monochrome printing mode to the color printing mode, a predetermined switching time period is needed. Hence, the control unit 15 does not start a subsequent printing operation until at least the movements of the photoconductive drums 11K, 11Y, 11M, and 11C are completed when the printing mode is required to be switched.

2. Control of Printer

### 2.1. Print Job Table

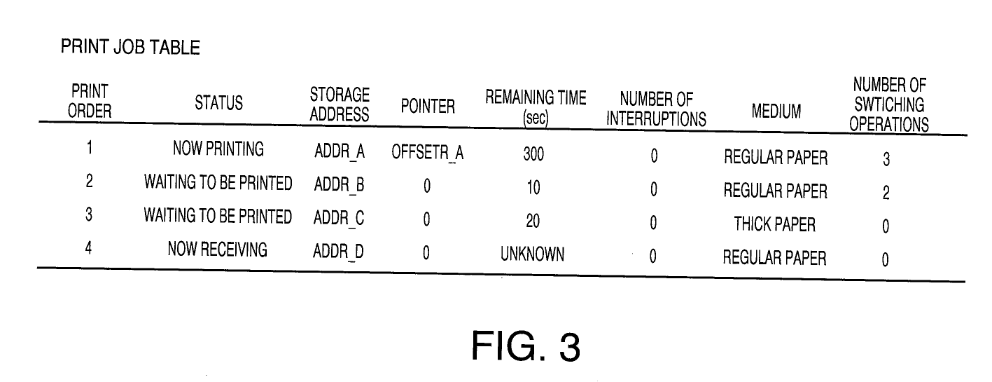

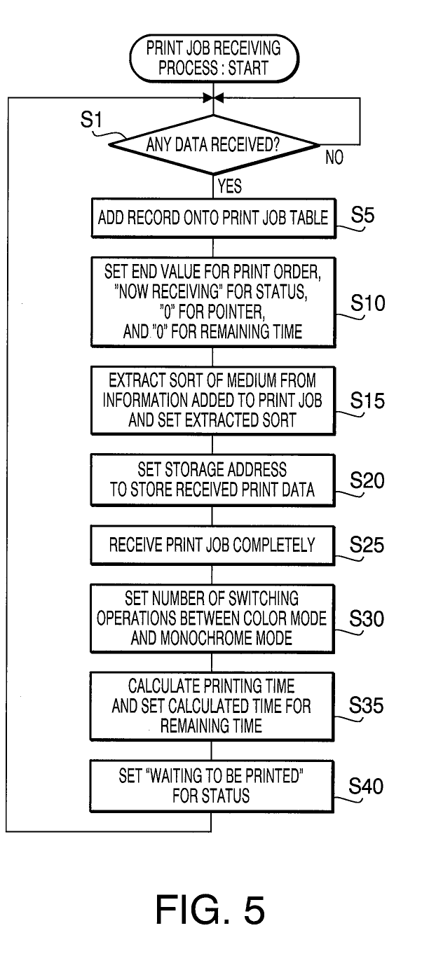

When receiving a print job (print data file) transmitted by a computer (not shown) via a network cable, the printer 10 creates a print job table as shown in FIG. 3 in accordance with a flowchart shown in FIG. 5, and rasterizes the received print job, generally, in accordance with a print order set on the print job table, and then performs a printing operation with the printing unit 11 based on the rasterized print job. Here, it is noted that FIG. 5 is a flowchart showing a print job receiving process to be executed when a print job is received.

Further, as shown in FIG. 3, the print job table includes items of a print order, status, storage address, pointer, remaining time, number of interruptions, medium, and number of switching operations. The item of print order indicates a number (information) representing an order of priority for a corresponding print job to be executed. The item of status indicates a working status of the print job such as “now printing,” “waiting to be printed,” and “now receiving.”

In addition, the item of storage address indicates a memory address to store the print job. The item of pointer indicates information representing a location, on the basis of a start location of job data constituting the print job, where the printing operation is actually completed. The item of remaining time indicates a time period required for printing the remainder of the job data from the location specified by the pointer, namely, a time period necessary for completing the printing of unprinted pages of the job data.

The item of number of interruptions indicates a number representing how many times an operation to interrupt a print job in execution and perform another print job (hereinafter referred to as interruption process) has been performed. The item of medium indicates the sort of the recording medium. The item of number of switching operations indicates the number of operations of switching the printing mode to be implemented for printing unprinted pages of the job data.

Further, an area (hereinafter referred to as a record) to write thereinto information such as a storage address and remaining time for a received print job is secured in a rewritable storage means such as RAM, and the information is written into the record, so that the print job table is created as shown in FIG. 3. After a print job is received, intended information on the print job table is updated as required in process of printing.

It is noted that the flowchart shown in FIG. 5 represents a control process to be booted when the printer 10 is powered on. The control process is terminated when the printer 10 is powered off. When the control process shown in FIG. 5 is booted, it is determined whether there is any print job to be received (S1). When it is determined that there is a print job to be received (S1: Yes), a new record for the print job is added onto the print job table (S5).

Subsequently, a number representing the last print order is set in a field for the print order of the added record, “now receiving” is set in a field for the status, and “0” is set in fields for the pointer and the remaining time (S10). Next, the sort of the recording medium extracted from information added to the print job is set in a field for the medium (S15). Then, a memory address on the RAM of the control unit 15 to store the print job which is currently being received is set in a field for the address (S20).

After the print job is completely received (S25), the received print data is analyzed. Specifically, the number of switching operations between a page to be printed in the color printing mode and a page to be printed in the monochrome printing mode is counted, and then the counted number is set in a field for the number of switching operations (S30).

Additionally, based on the analyzed print data, a time period taken for completing the printing operation is calculated as a product of the number of pages of the print job and a predetermined time period and set in the field for the remaining time (S35). Then, “waiting to be printed” is set in the field for the status (S40).

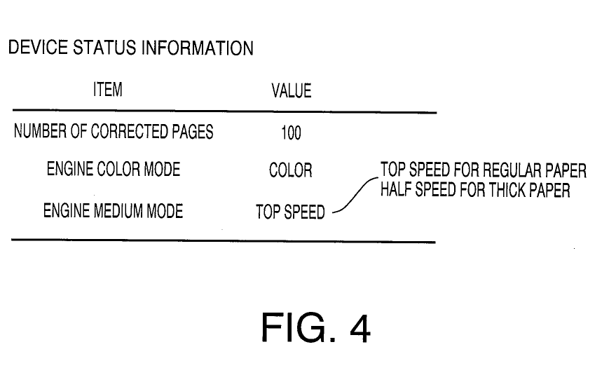

FIG. 4 is an example of a device status information table for the printer 10. In FIG. 4, the number of corrected pages represents a total number of pages printed after previous color shift correction has been implemented in the printing unit 11. When the number of corrected pages is more than a predetermined value F, correction processing such as color shift correction is implemented.

An engine color mode represents a currently-applied printing mode. Further, an engine medium mode represents a printing speed. It is noted that when the recording medium is a regular paper, the engine medium mode is set to be “Top Speed (maximum printing speed).” Furthermore, when the recording medium is a thick paper, the engine medium mode is set to be “Half Speed (half as high as the maximum printing speed).”

### 2.2. Print Control

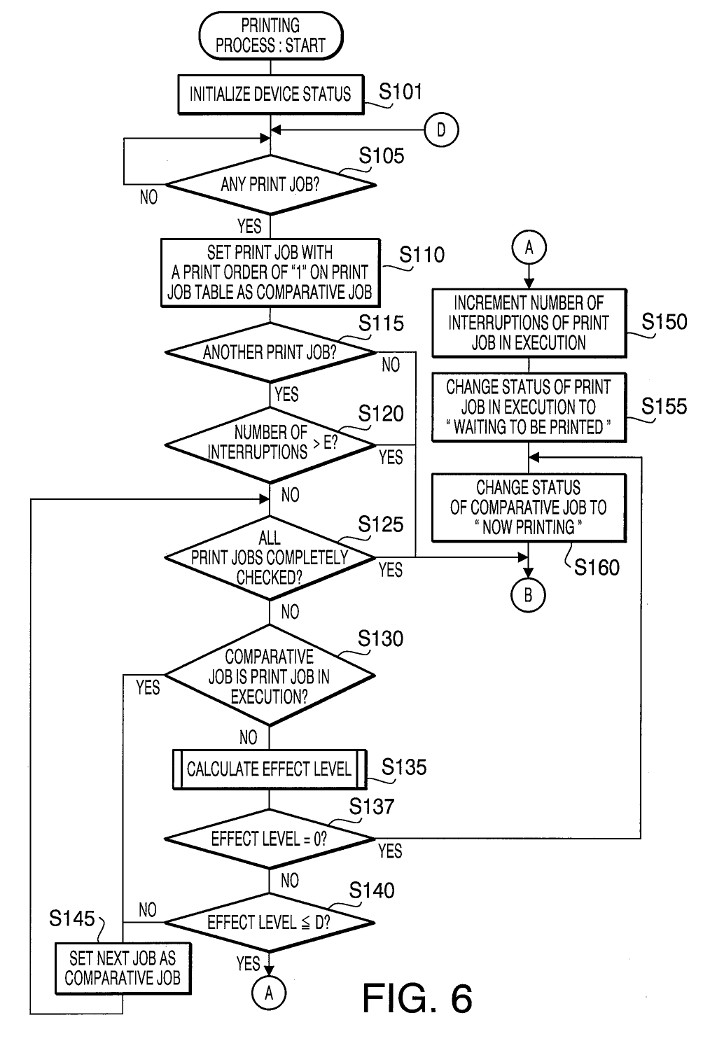

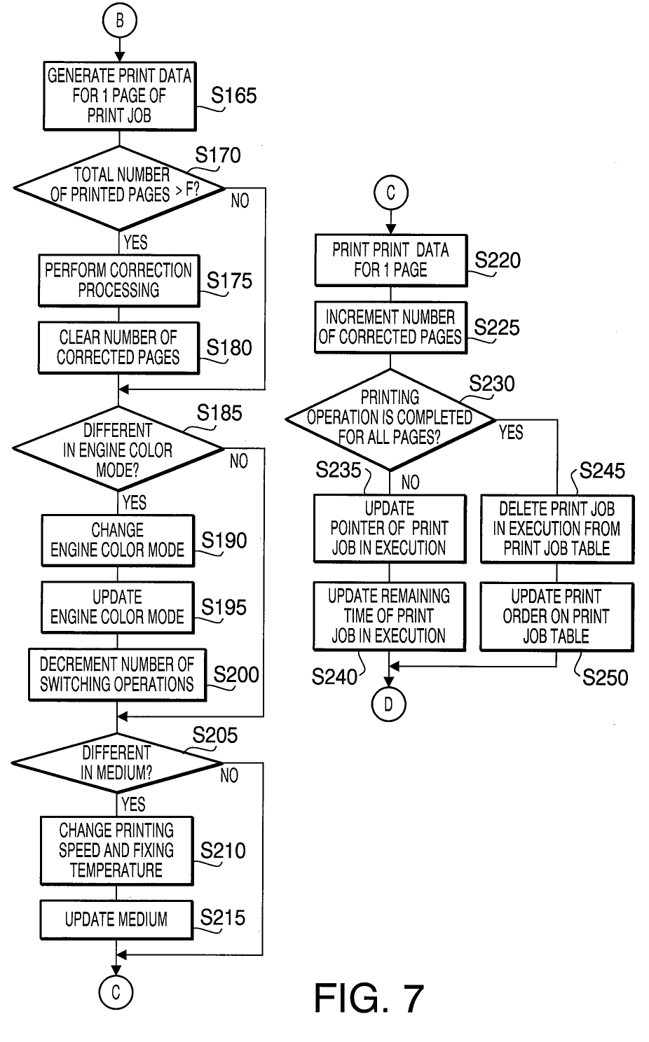

FIGS. 6 and 7 are flowcharts showing a print control process to be executed when the printer 10 is powered on. The print control process (FIGS. 6 and 7) and the print job receiving process (FIG. 5) are executed independently in parallel while the printer 10 is on.

When the print control process is booted, firstly, the device status (see FIG. 4) is initialized (S101), it is determined whether there is any print job on the print job table (S105). When it is determined that there is no print job on the print job table (S105: No), the printer 10 keeps waiting ready.

When it is determined that there is a print job on the print job table (S105: Yes), a record of a print job with a print order of “1” on the current print job table is copied in a specific area secured for a comparative job on the memory, and the print job with the print order of “1” is set as the comparative job (S110).

It is noted that there is no print job which is being executed at a moment when a first print job is received after the printer 10 has been powered on.

Subsequently, it is determined whether there is on the print job table any print job other than the print job set as the comparative job (S115). When it is determined that there is a print job (S115: Yes), it is determined whether the number of interruptions to the print job in execution is more than a predetermined value E (S120).

When it is determined that the number of interruptions to the print job in execution is less than the predetermined value E (S120: No), it is determined whether all print jobs are completely checked (S125).

At this time, when it is determined that all print jobs are not completely checked (S125: No), it is determined based on the print job table whether the comparative job is a print job in execution (S130). When it is determined that the comparative job is not a print job in execution (S130: No), an effect level is calculated (S135).

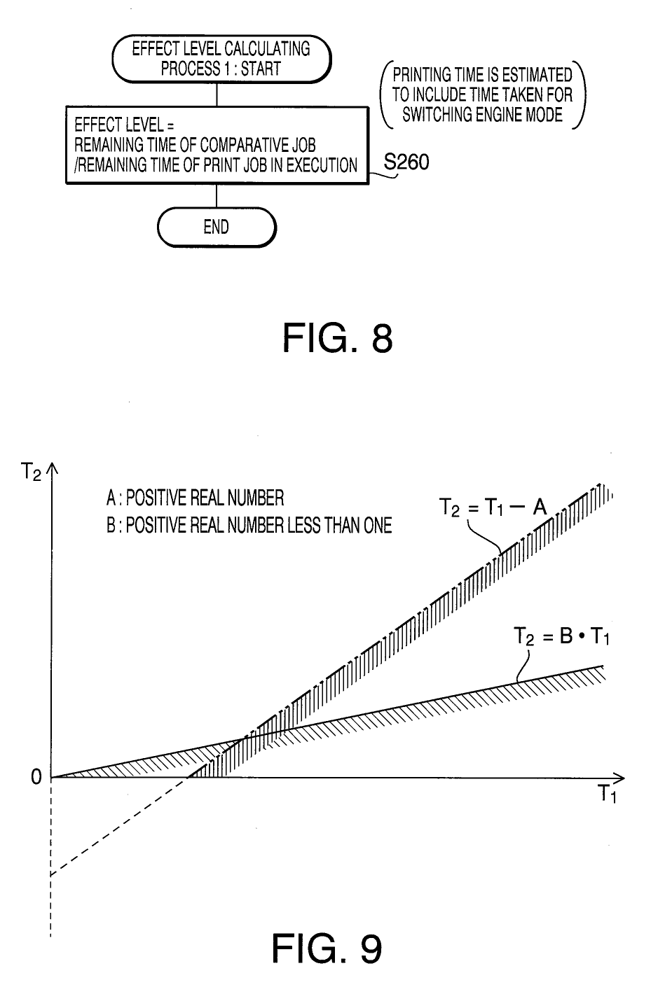

Here, FIG. 8 is a flowchart showing an effect level calculating process, and the effect level is calculated in a manner as shown in S260 of FIG. 8. Specifically, the effect level is a ratio (T2/T1) of a remaining printing time T2 of the comparative job to a remaining printing time T1 of the print job in execution. Incidentally, the times T1 and T2, and the print job in execution are extracted from the print job table.

Additionally, even though a plurality of print jobs are registered in the print job table, when the step S135 is firstly performed in a state where no printing operation is performed, namely, only after the printer 10 keeps waiting ready in S105, the step S135 is executed with no print job started. In this case, since there is no print job in execution, the effect level cannot be calculated. Thus, in the present embodiment, the effect level is set to “0” in such a case.

Subsequently, it is determined whether the effect level is “0” (S137). When it is determined that the effect level is not “0” (S137: No), it is determined whether the effect level calculated in S135 is less than or equal to a predetermined value D (S140).

When it is determined that the effect level is less than or equal to the predetermined value D (S140: Yes), the control unit 15 increments the number of interruptions of the print job in execution by one (S150), and changes the status of the print job in execution into “waiting to be printed” (S155). Then, the control unit 15 changes the status of the comparative into “now printing” (S160), and generates print data for a page of the print job in execution (S165).

As described above, when printing of any print job is not started, namely, when the effect level is determined to be “0” (S137: Yes), the step S160 is executed.

Meanwhile, when it is determined that the comparative job is a print job in execution in S130 (S130: Yes), or when it is determined that the effect level is more than the predetermined value D in S140 (S140: No), a next print job to the print job currently set as the comparative job on the print job table is set as the comparative job.

Thereafter, it is determined again whether all of the print jobs are completely checked (S125). When it is determined that all of the print jobs are completely checked (S125: Yes), print data for a page of the print job in execution is generated (S165).

Next, it is determined whether the total number of pages printed after previous color shift correction (the number of corrected pages in FIG. 4) is more than the predetermined value F (S170). When it is determined that the total number of pages is less than the predetermined value F (S170: No), it is determined whether it is required to switch the engine color mode from the current printing mode to another printing mode in order to print the print data generated in S165 (S185).

Meanwhile, when it is determined that the total number of pages is more than the predetermined value F (S170: Yes), the correction processing such as color shift correction is performed (S175). Then, the number of corrected pages (see FIG. 4) is reset to an initial value “0” (S180), and thereafter it is determined whether it is required to switch the engine color mode from the current printing mode to another printing mode (S185).

When it is determined that it is not required to switch the engine color mode from the current printing mode to another printing mode, namely, when it is determined that the current printing mode is the same as a printing mode of the print data generated in S165 (S185: No), it is determined whether a current engine medium mode is different from an engine medium mode of the print data generated in S165, namely, whether the sort of the recording medium is changed (S205).

Meanwhile, when it is determined that the engine color mode is to be changed (S185: Yes), the state of the printing unit 11 (printer engine) is changed from the state shown in FIG. 2A to that shown in FIG. 2B, or from the state shown in FIG. 2B to that shown in FIG. 2A (S190). Then, the engine color mode of the device status information (see FIG. 4) is updated (S195), and the number of switching operations on the print job table is decremented by one (S200). Thereafter, it is determined whether the sort of the recording medium has been changed (S205).

When it is determined that the sort of the recording medium has not been changed (S205: No), the print data of a page generated in S165 is printed (S220). Meanwhile, when it is determined that the sort of the recording medium has been changed (S205: Yes), the image forming mechanism (printer engine) is reconfigured to have a printing speed and fixing temperature suitable for the changed recording medium (S210). Then, the engine medium mode of the device status information is updated with contents reconfigured in S210 (S215). Thereafter, the print data of a page generated in S165 is printed (S220).

Subsequently, the number of corrected pages (see FIG. 4) is incremented by one (S225), and thereafter it is determined whether the printing operation is completed for all pages of the print job in execution (S230). When it is determined that the printing operation is completed for all pages of the print job in execution (S230: No), the value of the pointer (see FIG. 3) of the print job in execution is updated with information representing a point where the printing operation is completed (S235). In addition, the remaining time (see FIG. 3) of the print job in execution is updated (S240), and the step S105 is re-executed.

Meanwhile, when it is determined that the printing operation is completed for all pages of the print job in execution (S230: Yes), the print job in execution is deleted from the print job table (S245). Then, the print order (see FIG. 3) on the print job table is updated (S250), and thereafter the step S105 is re-executed.

3. Features of Printer in First Embodiment

FIG. 9 is a graph showing a comparison between the related art and the present embodiment of the invention regarding an effect level where the interruption process is permitted. In FIG. 9, a horizontal axis represents the remaining printing time T1 of a print job in execution (an interrupted print job), while a vertical axis represents the printing time T2 of an interrupting print job.

In the technique described in '279 Publication, the interruption process is permitted when a time difference between the times T1 and T2 is equal to or longer than a predetermined value A. The above condition can be written by a following expression 1:

T1−T2≧A□□□ expression 1,

where A represents a positive real number.
Subsequently, by solving the expression 1 for the time T2, a following expression 2 is obtained:

T2≦T1−A□□□ expression 2

Further, in the present embodiment, the interruption process is permitted when the ratio of the time T2 to the time T1 is equal to or less than a predetermined value. The above condition can be written by a following expression 3:

T2/T1≦B□□□ expression 3,

where B represents a positive real number less than 1.
Next, by solving the expression 3 for the time T2, a following expression 4 is obtained:

T2≦B□T1□□□ expression 4

The expression 2 is satisfied in an area below a chain double-dashed line shown in FIG. 9. The expression 4 is satisfied in an area below a solid line shown in FIG. 9. As is clear from FIG. 9 as well, since B is a positive real number less than 1, the longer the remaining printing time T1 is, the more the interruption process is likely to be permitted in the technique disclosed in '279 Publication than the present embodiment. Meanwhile, in the present embodiment, the longer the time T1 is, the less the interruption process is likely to be permitted than the technique disclosed in '279 Publication.

Further, in the present embodiment, the effect level (“B” in the expression 4) of the interrupting print job to the interrupted print job is constant regardless of the length of the time T1. Therefore, it is possible to lessen a sense of inequality held by each of an interrupting user and an interrupted user and to improve the convenience and user-friendliness of the printer 10.

Additionally, in the present embodiment, it is determined whether to permit the interruption process each time a predetermined amount of print data (in this case, a page of print data) is printed. Hence, it is possible to appropriately determine the priority of data to be printed so as to meet print requests varying momentarily.

### Second Embodiment

In the first embodiment, the effect level is calculated in consideration of the ratio of the printing time (remaining time) T2 of a print job (hereinafter referred to as a second print job) to the remaining printing time T1 of a print job in execution (hereinafter referred to as a first print job). In a second embodiment, the effect level is calculated in consideration of a time T3 that is a sum of the time T2, a time Tca taken for switching from a printing operation for the first print job to a printing operation for the second print job, and a time Tcb taken for switching from the printing operation for the second print job to the printing operation for the first print job (time T3=Tca+Tcb+T2). Then, the interruption process is permitted when a ratio (T3/T1) of the time T3 to the time T1 is equal to or less than a predetermined value.

1. Calculation of Effect Level

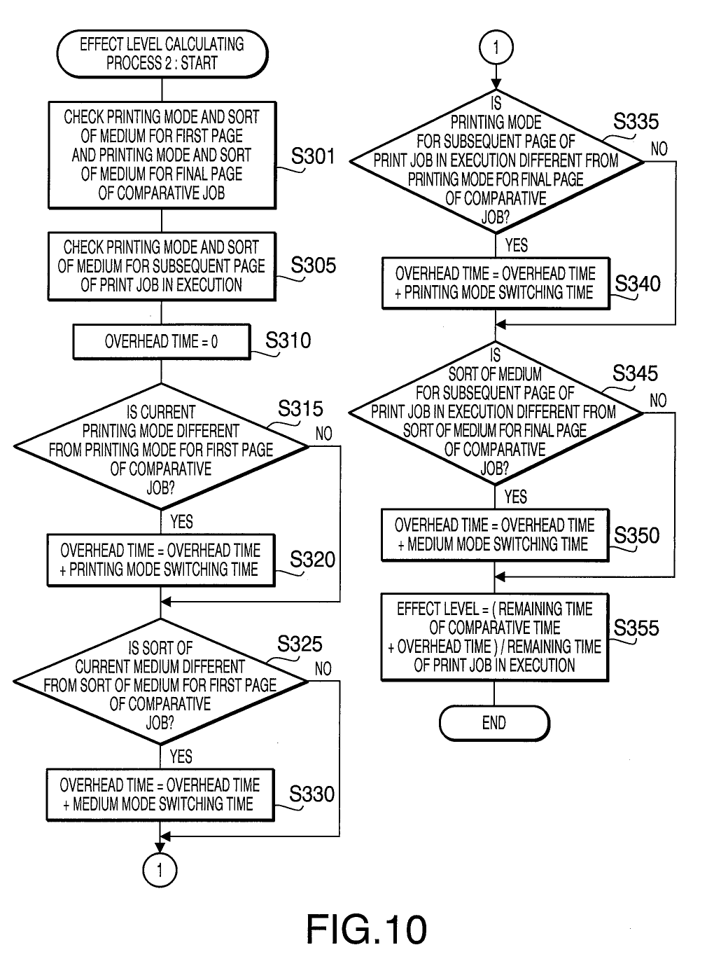

FIG. 10 is a flowchart showing a process to calculate the effect level (detailed procedure of the step S135) in the present embodiment. Hereinafter, referring to FIG. 10, the process to calculate the effect level will be explained.

When the process to calculate the effect level is booted, firstly, the following are acquired: information representing a printing mode and a sort of a recording medium for a first page of a comparative job, and information representing a printing mode and a sort of a recording medium for a final page of the comparative job (S301). Then, information representing a printing mode and a sort of a recording medium for a subsequent page to be printed of a print job in execution is acquired (S305).

In the present embodiment, the sort of the recording medium is configured to be the same for a single print job. However, by performing the steps such as S301 and S305, it is possible to meet a case where the sort of the recording medium is configured on a page-by-page basis.

Then, “0” is substituted for an overhead time as an initial value thereof (S310), and thereafter it is determined whether the current printing mode is different from the printing mode for the first page of the comparative job, based on the device status information (see FIG. 4) and information acquired in S301 (S315).

When it is determined that the printing modes are not different from each other (S315: No), it is determined whether the sort of the current recording medium is different from the sort of the recording medium for the first page of the comparative job, based on the device status information (see FIG. 4) and information acquired in S301 (S325).

Meanwhile, when it is determined that the printing modes are different from each other (S315: Yes), a time obtained by adding a time taken for switching the printing mode to the current overhead time is substituted for the overhead time (S320). Thereafter, it is determined whether the sort of the current recording medium is different from the sort of the recording medium for the first page of the comparative job, based on the device status information (see FIG. 4) and information acquired in S301 (S325).

When it is determined that the sorts of the recording media are not different from each other (S325: No), it is determined whether the printing mode for a subsequent page of the print job in execution is different from the printing mode for the final page of the comparative job, based on the information acquired in S301 and S305 (S335).

Meanwhile, when it is determined that the sorts of the recording media are different from each other (S325: Yes), a time obtained by adding a time taken for switching the recording medium to the current overhead time is substituted for the overhead time (S330). Thereafter, it is determined whether the printing mode for a subsequent page of the print job in execution is different from the printing mode for the final page of the comparative job, based on the information acquired in S301 and S305 (S335).

When it is determined that the printing modes are not different from each other (S335: No), it is determined whether the sort of the recording medium for a subsequent page of the print job in execution is different from the sort of the recording medium for the final page of the comparative job (S345).

Meanwhile, when it is determined that the printing modes are different from each other (S335: Yes), a time obtained by adding a time taken for switching the printing mode to the current overhead time is substituted for the overhead time (S340). Thereafter, it is determined whether the sort of the recording medium for a subsequent page of the print job in execution is different from the sort of the recording medium for the final page of the comparative job (S345).

When it is determined that the sorts of the recording media are not different from each other (S345: No), a calculation is made to find a ratio of the time T3, which is obtained by adding the remaining printing time T2 of the comparative job to the overhead time, to the remaining printing time T1 of the print job in execution (S355), and thereafter the present process is terminated.

Meanwhile, when it is determined that the sorts of the recording media are different from each other (S345: Yes), a time obtained by adding a time taken for switching the recording medium to the current overhead time is substituted for the overhead time (S350). Thereafter, a calculation is made to find a ratio of the time T3, which is obtained by adding the remaining printing time T2 of the comparative job to the overhead time, to the remaining printing time T1 of the print job in execution (S355), and then the present process is terminated.

2. Features of Printer in Second Embodiment

In the present embodiment, it is determined whether to permit the interruption process in consideration of the time taken for switching the print job. Therefore, it can be avoided more certainly that the printer 10 might be less convenient and less user-friendly for users who have issued print commands.

As is clear from the flowchart shown in FIG. 10, in the present embodiment, depending on the relationship between the comparative job and the print job in execution, at least one of the Tca taken for switching from the printing operation for the first print job to the printing operation for the second print job and the time Tcb taken for switching from the printing operation for the second print job to the printing operation for the first print job may be added to the remaining time T2 of the second print job. Alternatively, neither Tca nor Tcb may be added to T2 as well.

Hereinabove, the embodiments according to aspects of the present invention have been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

(Modifications)

In the second embodiment, the effect level is determined in consideration of any of the Tca taken for switching from the printing operation for the first print job to the printing operation for the second print job and the time Tcb taken for switching from the printing operation for the second print job to the printing operation for the first print job. However, the effect level may be determined in view of only either Tca or Tcb.

Further, the predetermined value D may freely be configured. When the predetermined value D is set smaller, even though the interruption process is carried out, the effect level of a job which interrupts the print job in execution can be made smaller.

Additionally, the printing unit 11 is not limited to the configuration shown in the aforementioned embodiment, and any other printer engines may be employed for the printer unit 11.

What is claimed is:

1. A printing device configured to execute a print job and perform a printing operation based on the print job, comprising:
an interruption unit configured to perform an interruption process for interrupting a first print job in execution and executing a second print job;
a calculating unit configured to calculate a ratio of a second time taken for a printing operation for the second print job to a first time taken for a printing operation for unprinted pages of the first print job; and
a control unit configured to allow the interruption unit to perform the interruption process based on the ratio calculated by the calculating unit.

2. The printing device according to claim 1, further comprising a determining unit configured to determine whether the ratio calculated by the calculating unit is less than or equal to a predetermined value,
wherein the control unit allows the interruption unit to perform the interruption process when the determining unit determines that the ratio is less than or equal to the predetermined value.

3. A printing device configured to execute a print job and perform a printing operation based on the print job, comprising:
an interruption unit configured to perform an interruption process for interrupting a first print job in execution and executing a second print job;
a calculating unit configured to calculate a ratio of a third time to a first time taken for a printing operation for unprinted pages of the first print job, the third time being obtained by adding, to a second time taken for a printing operation for the second print job, at least one of a time taken for switching from the printing operation for the first print job to a printing operation for the second print job and a time taken for switching from the printing operation for the second print job to the printing operation for the first print job; and
a control unit configured to allow the interruption unit to perform the interruption process based on the ratio calculated by the calculating unit.

4. The printing device according to claim 3, further comprising a determining unit configured to determine whether the ratio calculated by the calculating unit is less than or equal to a predetermined value,
wherein the control unit allows the interruption unit to perform the interruption process when the determining unit determines that the ratio is less than or equal to the predetermined value.

5. The printing device according to claim 3,
wherein the third time is obtained by adding, to the second time taken for the printing operation for the second print job, both of the time taken for switching from the printing operation for the first print job to the printing operation for the second print job and the time taken for switching from the printing operation for the second print job to the printing operation for the first print job.

6. The printing device according to claim 5, further comprising a determining unit configured to determine whether the ratio calculated by the calculating unit is less than or equal to a predetermined value,
wherein the control unit allows the interruption unit to perform the interruption process when the determining unit determines that the ratio is less than or equal to the predetermined value.

7. A computer readable medium having computer readable instructions stored thereon, which cause a computer, configured to perform an interruption process to interrupt a first print job in execution and execute a second print job, to perform the steps of:
calculating a ratio of a second time taken for a printing operation for the second print job to a first time taken for a printing operation for unprinted pages of the first print job;
determining whether the ratio calculated in the calculating step is less than or equal to a predetermined value; and
performing the interruption process when it is determined in the determining step that the ratio is less than or equal to the predetermined value.
